(19) United States
(12) Patent Application Publication
(10) Pub. No.: US 2009/0100281 A1
(43) Pub. Date: Apr. 16, 2009

(54) COMMUNICATION DEVICE AND COMMUNICATION METHOD

(75) Inventors: Daisuke WATANABE, Yokohama (JP); Yoshikazu MOTOMURA, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki-shi (JP)

(21) Appl. No.: 12/336,607

(22) Filed: Dec. 17, 2008

Related U.S. Application Data
(63) Continuation of application No. PCT/JP2006/312238, filed on Jun. 19, 2006.

(51) Int. Cl. G06F 1/32

(52) U.S. Cl. 713/323

(57) ABSTRACT

A communication method includes transmitting a first transition notification of a sleep mode to make allotment of a channel time unnecessary to a first host, and communicating first data to a second host in a first transition state which the first host transits to the sleep mode.

### FIELD

The present application relates to a communication device and a communication method.

### BACKGROUND

There exists a wireless USB (Universal Serial Bus) being a standard of high-speed short-distance radio communication. This wireless USB is supposed to be applied to a product needing high-speed radio communication in a short-distance, such as a personal computer (PC) and a peripheral apparatus such as a hard disk drive apparatus (HDD). A product to which the above-described standard is applied for short-distance radio communication is presumed to become commonly used in the future, and there is also estimated a usage form in which a plurality of computers share one peripheral apparatus such as the HDD. However, a definition corresponding to such a usage form does not exist in the standard of the wireless USB.

However, as a conventional technology, there is a method in which, in order to simultaneously receive incoming calls from two different communication networks of private radio communication network and wide area cellular network in a radio communication terminal, the incoming call to the radio communication terminal is limited by using sleep modes for both the communication network, and when confirming an existence of the incoming call in beacons or paging messages received periodically, the radio communication terminal accesses a network and accepts the call (see Patent Document 1).

In Patent Document 2, there is described a computer peripheral device including a connection signal receiver receiving from a host a host connection signal indicating connection to the host, a connection signal transmitter transmitting to the host a signal indicating connection/non-connection to the host, and a controller monitoring continuance of communication with the host and, when communication does not continue for a predetermined time, making the connection signal transmitter transmit to the host a signal indicating non-connection and performing transition to a low power consumption mode.

Patent Document 3 describes a USB system in which a device used by each host is used by another host as necessary without switching a connection.

However, since a wireless USB does not have a signal periodically notifying existence/absence of accumulated data during a sleep operation, such as a beacon and a paging message, if the above-described technologies are applied, compatibility with another wireless USB compliant product is impaired.

Patent Document 1: Japanese Translated National Publication of Patent Application No. 2000-517131

Patent Document 2: Japanese Laid-open Patent Publication No. 2001-67156

Patent Document 3: Japanese Laid-open Patent Publication No. 2001-256172

### SUMMARY

According to aspects of the embodiment, a communication method includes transmitting a first transition notification of a sleep mode to make allotment of a channel time unnecessary to a first host, and communicating first data to a second host in a first transition state which the first host transits to the sleep mode.

It is to be understood that both the foregoing general description and the following detailed description are exemplary and explanatory only and are not restrictive of the invention, as claimed.

### BRIEF DESCRIPTION OF DRAWINGS

FIG. 1 is a diagram illustrating a configuration example of a wireless USB system according to an embodiment;

FIG. 2 is a block diagram illustrating a hardware configuration example of hosts and devices according to the present embodiment;

FIG. 3 is a diagram illustrating a communication format example of a wireless USB;

FIG. 4 is a flowchart illustrating a processing example of a first host, a first device and a second host according to the present embodiment;

FIG. 5 is a flowchart, continued from FIG. 4, illustrating the processing example of the first host, the first device and the second host according to the present embodiment;

FIG. 6 is a flowchart, continued from FIG. 5, illustrating the processing example of the first host, the first device and the second host according to the present embodiment;

FIG. 7 is a flowchart, continued from FIG. 6, illustrating the processing example of the first host, the first device and the second host according to the present embodiment;

FIG. 8 is a flowchart, continued from FIG. 7, illustrating the processing example of the first host, the first device and the second host according to the present embodiment; and

FIG. 9 is a flowchart, continued from FIG. 8, illustrating the processing example of the first host, the first device and the second host according to the present embodiment.

### DESCRIPTION OF EMBODIMENTS

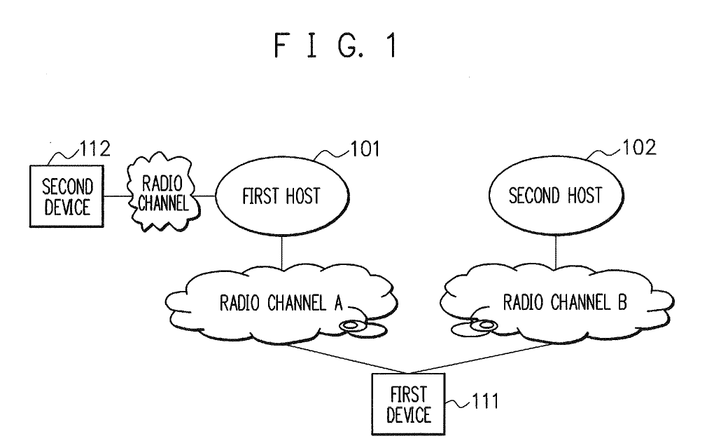

FIG. 1 is a diagram illustrating a configuration example of a wireless USB (Universal Serial Bus) system according to an embodiment. A first device 111 may radio-communicate with a first host 101 via a radio channel A and may radio-communicate with a second host 102 via a radio channel B, by a wireless USB. A second device 112 may radio-communicate with the first host 101 via a radio channel by the wireless USB. The first host 101 may perform communication with the first device 111 and the second device 112. The first device 111 is a radio apparatus capable of maintaining simultaneous connection with a plurality of the hosts 101 and 102. The first host 101 and the second host 102 respectively perform transmission/reception with devices within their radio areas. The first device 111 uses the radio channels A and B respectively to start sessions with the first host 101 and the second host 102, and then performs transmission/reception of data.

For example, the hosts 101, 102 are personal computers and the like, while the devices 111, 112 are radio communication devices of digital cameras or peripheral apparatuses such as a hard disk drive apparatus. The hosts 101, 102 and the devices 111, 112 are wireless USB devices used for short-distance radio communication. The first device 111 is a wireless USB device realizing a plurality of channel sessions with the plural hosts 101, 102 while maintaining compatibility with another wireless USB compliant product.

FIG. 2 is a block diagram illustrating a hardware configuration example of the hosts 101, 102 and the devices 111, 112 according to the present embodiment.

For example, the hosts 101 and 102 are the personal computers while the devices 111,112 are the digital cameras.

To a bus 201 are connected a central processing unit (CPU) 202, a ROM 203, a RAM 204, a radio communication section 205, an input unit 206, an output unit 207, an external storage unit 208 and a timer 209.

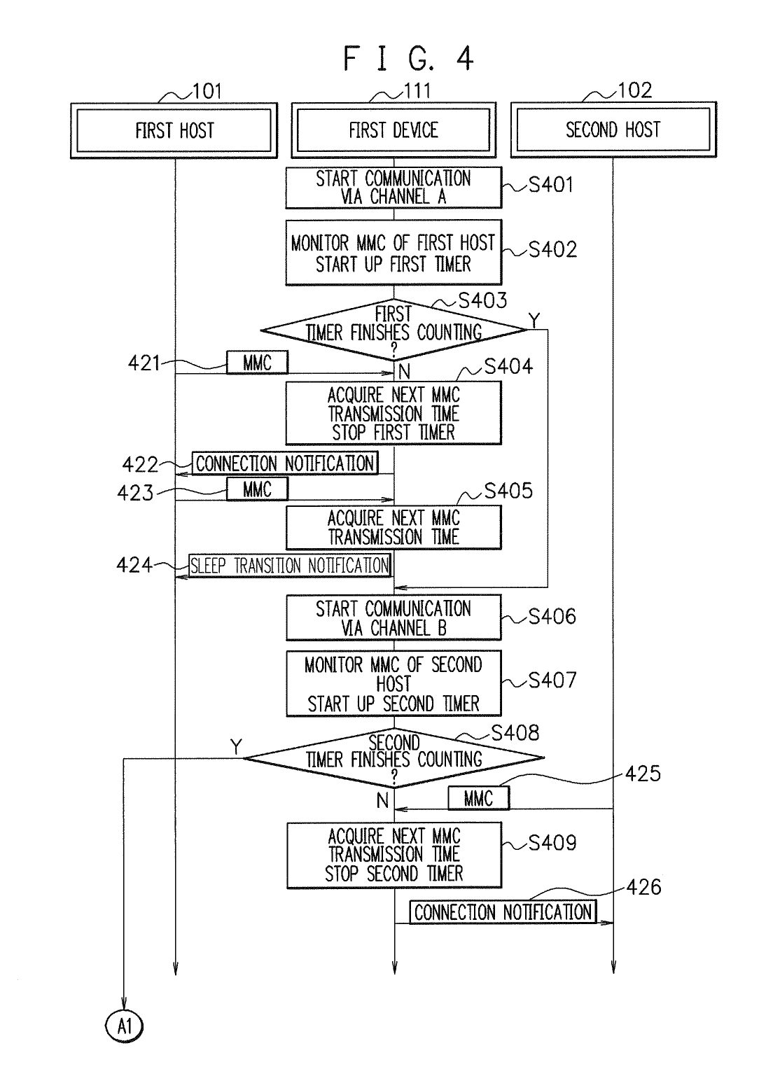

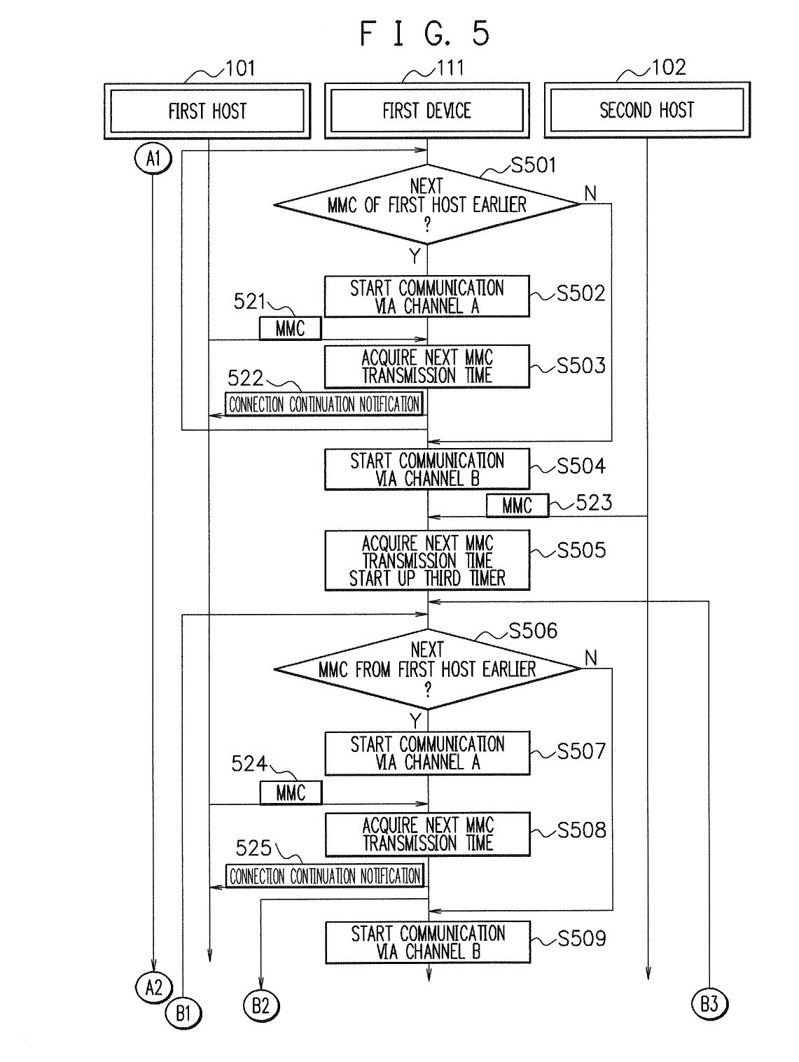

The CPU 202 performs a processing or a computation of data and controls each kind of component connected via the bus 201. Control procedures (computer program) of the CPU 202 are stored in advance in the ROM 203 and the CPU 202 performs this computer program, whereby processings and the like of FIG. 4 to FIG. 9 are performed. It may be possible that a computer program is stored in the external storage unit 208 and the computer program is copied in the RAM 204, to be performed by the CPU 202, whereby the processings and the like of FIG. 4 to FIG. 9 are performed. The RAM 204 is used as a work memory for input/output of data or transmission/reception, and as a temporary memory for control of each component. The external storage unit 208 is, for example, a hard disk storage unit, a memory card and the like, and storage contents are not deleted even if a power source is turned off.

The radio communication section 205 may perform radio communication of the wireless USB or the like. The input unit 206 is, for example, a keyboard, a button or the like, and may perform various kinds of instructions, input or the like. The output unit 207 is a display or the like. The timer 209 counts time and outputs a count value.

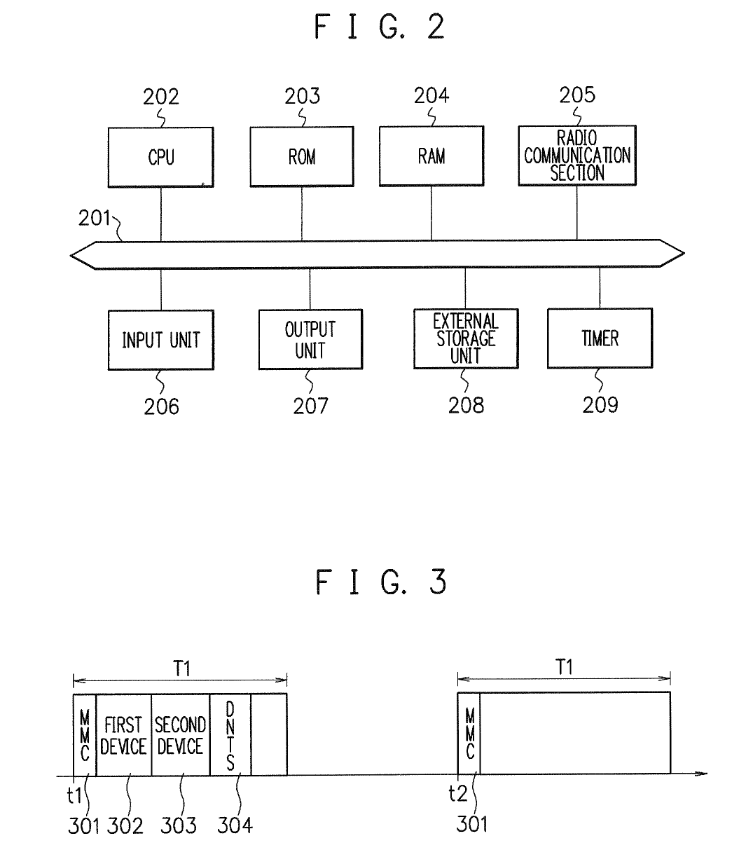

FIG. 3 is a diagram showing a communication format example of a wireless USB. A horizontal axis indicates a time. A time T1 is a time usable for communication of the first host 101.

In the wireless USB, one radio control apparatus called the host 101 time-divides and allot a radio channel to a plurality of radio communication apparatuses called the devices 111 and 112, and includes the allotment information in a control signal 301 called an MMC (Micro-scheduled Management Command) to be transmitted continually in the radio channel, to notify the entire radio communication area of the radio control apparatus. The MMC 301 is transmitted to the entire radio communication area of the radio control apparatus. Each MMC 301 includes transmission time information of a next MMC 301. For example, an MMC 301 of a time t1 includes information of a transmission time t2 of a next MMC 301.

Each of the devices 111 and 112 receives the MMC 301 and abstracts the allotment information included in the MMC 301, whereby each of the devices 111 and 112 may recognize a time allotted by the host 101 respectively, so that communication with the host 101 may be performed by using this allotted time. For example, an allotted time (radio channel time) 302 is a time allotted to the first device 111, while an allotted time (radio channel time) 303 is a time allotted to the second device 112. The first device 111 may perform communication with the first host 101 during the allotted time 302, while the second device 112 may perform communication with the first host 101 during the allotted time 303.

A competing access period 304 called a DNTS (Device Notification Time Slot) aiming at an unspecified device is also allotted among the allotted times, and each of the devices 111, 112 may transmit a signal such as a connection notification, a sleep mode transition notification, and an awake mode transition notification to the host 101 within this DNTS period 304. The respective devices 111, 112 start sessions with the host 101 by transmitting the connection notifications within the DNTS period 304, and, after starts of the sessions, may be allotted the radio channel times 302, 303 for communication from the host 101. Further, the respective devices 111, 112 may halt the allotment of the radio channel times 302, 303 for communication from the host 101 by transmitting the sleep mode transition notifications within the DNTS period 304. The respective devices 111, 112 may restart the allotment of the radio channel times 302, 303 for communication from the host 101 by transmitting the awake mode transition notifications within the DNTS period 304.

FIG. 4 to FIG. 9 are flowcharts illustrating a processing example of the first host 101, the first device 111 and the second host 102 according to the present embodiment. In FIG. 4, it is assumed that the first device 111 has exchanged authentication information necessary for a start of a session, with the first host 101 and the second host 102. First, in a step S401, the first device 111 tries to start a session with the first host 101 via the radio channel A. In a step S402, the first device 111 starts to monitor an MMC 301 from the first host 101 in order to detect a DNTS period 304 for transmitting a connection notification to the first host 101. Considering a case that the MMC is not transmitted from the first host 101, the first device 111 starts up a first timer to limit a monitor period of the MMC from the first host 101.

In a step S403, the first device 111 checks whether or not the first timer has finished counting a timer value. If the first timer has finished counting, the first device 111 skips the start of the session with the first host 101 and goes to a step S406. If the first device 111 receives an MMC 421 from the first host 101 before the first timer finishes counting, the first device 111 stops the first timer and abstracts and holds transmission time information of a next MMC 423 included in the MMC 421 in a step S404. Thereafter, when receiving the MMC from the first host 101, the first device 111 abstracts transmission time information of a next MMC each time and holds only the newest information as transmission time information of a next MMC of the first host 101.

Next, the first device 111 radio-transmits a connection notification 422 to request a connection start to the first host 101 within the DNTS period 304 allotted in the received MMC 421. Immediately after receiving the connection notification 422 from the first device 111, the first host 101 transmits the MMC 423 to the first device 111, with including a response to the connection notification 422.

Next, in a step 405, the first device 111 acquires transmission time information of a next MMC included in the MMC 423. If the first device 111 receives the MMC 423 including the response indicating permission of connection from the first host 101 after transmission of the connection notification to the first host 101, the first device 111 transmits a transition notification 424 to a sleep mode to the first host 101 within the DNTS period 304 allotted in the MMC 423. In other words, the first device 111 radio-transmits the transition notification 424 to the sleep mode to the first host 101 in order to make allotment of the radio channel time 302 of the first device 111 unnecessary. Hereby, the first device 111 performs transition to the sleep mode with respect to the first host 101, and transmission of a signal other than the MMC from the first host 101 to the device 111 is restrained.

In other words, when the first host 101 receives the sleep mode transition notification 424, it becomes unnecessary to allot the radio channel time 302 of the first device 111 and it may be possible to perform communication with another device, so that the number of communicable devices is increased. The first device 111 is in the sleep mode with respect to the first host 101 and performs data transmission/reception with the second host 102 thereafter. When the first device 111 performs data transmission/reception with either one of the hosts 101 and 102, the first device 111 becomes in the sleep mode with respect to the other host. The first device 111 is not able to perform access to both the hosts 101 and 102 simultaneously, and selects either one of the hosts 101 and 102 to perform access thereto.

Next, in a step S406, the first device 111 tries to start a session with the second host 102 via the radio channel B. In a step S407, the first device 111 starts to monitor an MMC from the second host 102 in order to detect a DNTS period for transmitting a connection notification to the second host 102. Considering a case that the MMC is transmitted from the second host 102, the first device 111 starts up a second timer to limit a monitor period of the MMC from the second host 102.

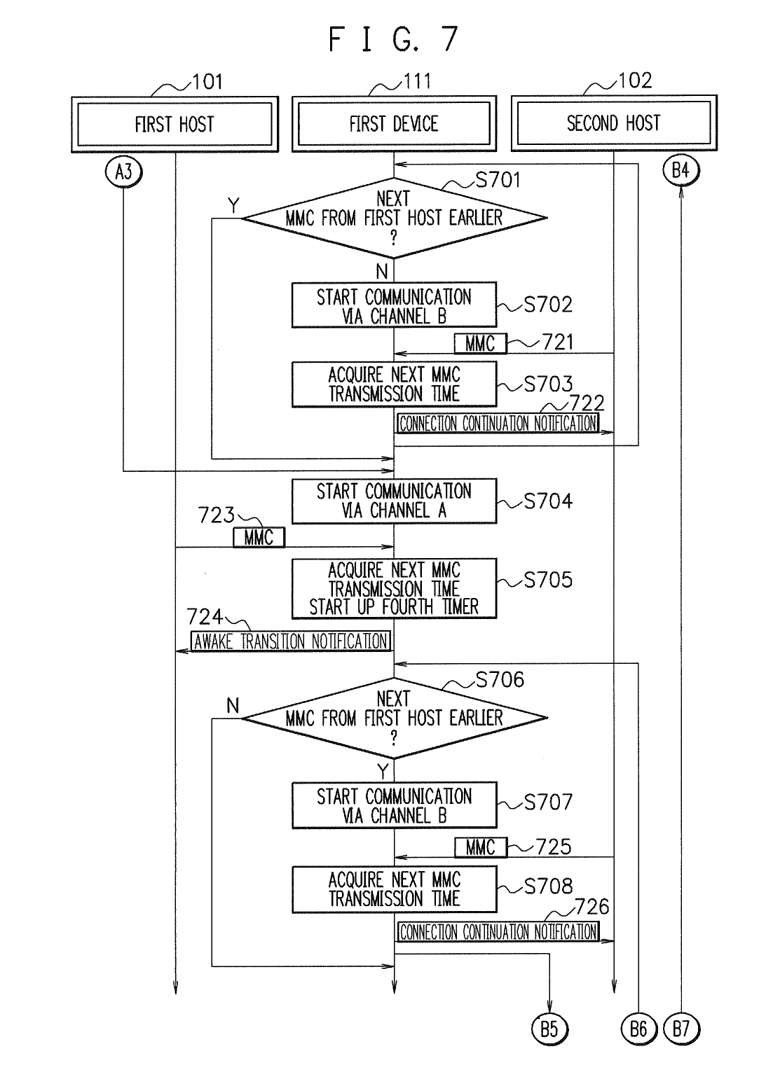

Next, in a step S408, the first device 111 checks whether or not the second timer has finished counting a timer value. If the second timer has finished counting, the first device 111 skips the start of the session with the second host 102 and goes to a step S704 in FIG. 7. If the first device 111 receives an MMC 425 from the second host 102 before the second timer finishes counting, the first device 111 stops the second timer and abstracts and holds transmission time information of a next MMC included in the MMC 425 in a step S409. Thereafter, when receiving the MMC from the second host 102, the first device 111 abstracts transmission time information of a next MMC each time and holds only the newest information as transmission time information of a next MMC of the second host 102. Then, the first device 111 radio-transmits a connection notification 426 to request a connection start to the second host 102 within a DNTS period 304 allotted in the received MMC 425. The second host 102 includes a response to the connection notification 426 among an MMC 523 (FIG. 5) to be transmitted immediately after receiving the connection notification 426 from the first device 111, and transmits the MMC 523.

Next, processings will be explained with reference to FIG. 5. Since the first device 111 has received the MMCs from the plural hosts of the first host 101 and the second host 102, as for processings thereafter, the next MMC transmission times of the first host 101 and the second host 102 are compared and if the transmission times do not coincide with each other, the processings are performed on the MMC to be transmitted precedingly. When the transmission times from the above-described respective hosts coincide with each other, the MMC of the host allowed the allotment of the radio channel time is given priority and the processings are performed thereon. However, if the MMC from the host allowed the allotment of the radio channel time is not included in the MMCs whose next transmission times coincide with each other, the MMC from an arbitrary host is given priority and the processings are performed thereon. If the transmission time of the next MMC becomes unobvious because reception is passed on due to the above-described reason, the reception of the MMC and acquisition of the next MMC transmission time are performed by monitoring the MMC when the allotment of the radio channel time is allowed to that host.

In a step S501, the first device 111 judges which of next MMC transmission times from the first host 101 and the second host 102 is earlier. If the next MMC transmission time from the first host 101 is earlier, the process goes to a step 502, while if the next MMC transmission time from the second host 102 is earlier, the process goes to a step S504.

In the step S502, the first device 111 tries to start a session with the first host 101 via the radio channel A. If the first device 111, after transmitting the connection notification 426 to the second host 102, receives an MMC 521 from the first host 101 before receiving an MMC 523 including a response to the connection notification 426 from the second host 102, the first device 111 acquires transmission time information of a next MMC included in the MMC 521 in a step S503 and transmits a connection continuation notification 522 within a DNTS period 304 allotted in the MMC 521. Thereafter, the process returns to the step S501 and similar processings are repeated.

The first device 111 has transmitted the sleep transition notification 424 to the first host 101 in FIG. 4. The first host 101 forcibly cuts off the radio channel to the first device 111 if access does not occur from the first device 111 for a predetermined time after the reception of the sleep transition notification 424. Thus, after transmitting the sleep transition notification 424, the first device 111 needs to transmit the connection continuation notification 522 to the first host 101 before a predetermined time passes, in a transit state to the sleep mode with respect to the first host 101, in order to evade forcible cut-off. The first device 111 may evade the forcible cut-off by periodically transmitting the connection continuation notification 522 to the first host 101 also thereafter.

In the step S504, the first device 111 tries to start a session with the second host 102 via the radio channel B. If the first device 111 receives the MMC 523 including the response indicating permission of connection from the second host 102, the first device 111 acquires transmission time information of a next MMC included in the MMC 523 and starts up a third timer in a step S505. The first device 111 continues to allow the allotment of the radio channel time from the second host 102 until the third timer finishes counting.

In a step S506, the first device 111 judges which of next MMC transmission times from the first host 101 and the second host 102 is earlier. If the next MMC transmission time from the first host 101 is earlier, the process goes to a step S507, while if the next MMC transmission time from the second host 102 is earlier, the process goes to a step S509.

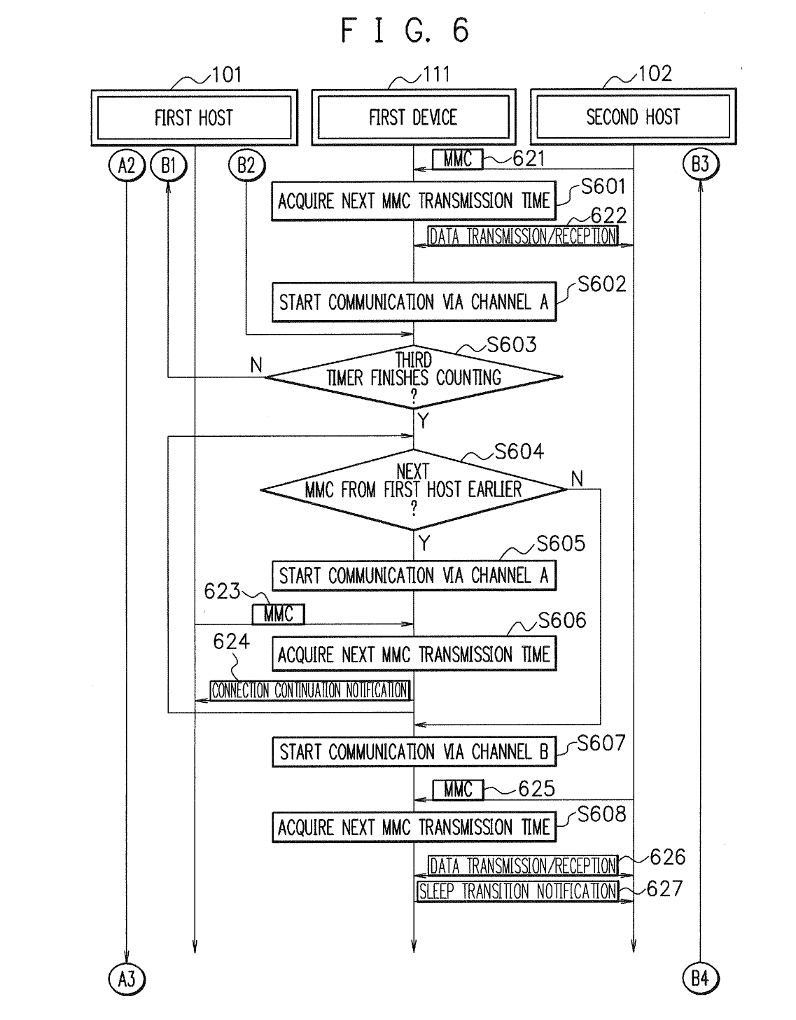

In the step S507, the first device 111 tries to start a session with the first host 101 via the radio channel A. If the first device 111 receives an MMC 524 from the first host 101 before the third timer finishes counting, the first device 111 acquires transmission time information of a next MMC included in the MMC 524 in a step S508, and transmits a connection continuation notification 525 within a DNTS period 304 allotted in the MMC 524. Thereafter, the process goes to a step S603 in FIG. 6.

In the step S509, the first device 111 tries to start a session with the second host 102 via the radio channel B. In FIG. 6, the first device 111 receives an MMC 621 from the second host 102 before the third timer finishes counting. In a step S601, the first device 111 acquires transmission time information of a next MMC included in the MMC 621. In a case that the first device 111 receives the MMC 621, if the radio channel time for transmission or reception of data between the second host 102 and the first device 111 is allotted, the first device 111 performs a transmitting or receiving processing 622 of the data to/from the second host 102 within the radio channel time indicated by the MMC 524. In other words, the first device 111 performs the radio communication processing 622 of data with the second host 102, in a transition state to the sleep mode with respect to the first host 101.

Next, in a step S602, the first device 111 tries to start a session with the first host 101 via the radio channel A.

Next, in the step S603, the first device 111 checks whether or not the third timer has finished counting a timer value. If the counting is not finished, the process returns to the step S506 in FIG. 5 and similar processings are repeated, while if the counting is finished, the process goes to a step S604.

In the step S604, the first device 111 judges which of next MMC transmission times from the first host 101 and the second host 102 is earlier. If the next MMC transmission time from the first host 101 is earlier, the process goes to a step 605, while if the next MMC transmission time from the second host 102 is earlier, the process goes to a step S607.

In the step S605, the first device 111 tries to start a session with the first host 101 via the radio channel A. After the third timer finishes counting, the first device 111 receives an MMC 623 from the first host 101 before receiving an MMC 625 from the second host 102.

Next, in a step S606, the first device 111 acquires transmission time information of a next MMC included in the MMC 623. The first device 111 transmits a connection continuation notification 624 to the first host 101 within a DNTS period 304 allotted in the MMC 623 received from the first host 101, to evade forcible cut-off. Thereafter, the process returns to the step S604 and similar processings are repeated.

In the step S607, the first device 111 tries to start a session with the second host 102 via the radio channel B. After the third timer finishes counting, the first device 111 receives the MMC 625 from the second host 102.

Next, in a step S608, the first device 111 acquires transmission time information of a next MMC included in the MMC 625. If a radio channel time for transmission or reception of data between the second host 102 and the first device 111 is allotted in the MMC 625 received from the second host 102, the first device 111 performs a transmission or reception processing 626 of data to/from the second host 102 within the radio channel time. Next, the first device 111 transmits a transition notification 627 to a sleep mode to the second host 102 within a DNTS period 304 allotted in the MMC 625 received from the second host 102, to declare cessation of transmission/reception of data. In other words, the first device 111 radio-transmits the transition notification 627 to the sleep mode to the second host 102 in order to make allotment of the radio channel time unnecessary.

It becomes unnecessary for the second host 102 to allot the radio channel time of the first device 111, and the second host 102 becomes able to perform communication with another device, so that the number of communicable devices is increased. The first device 111 is in the sleep mode with respect to the second host 102, and thereafter, performs data transmission/reception with the first host 101.

Next, in a step S701 in FIG. 7, the first device 111 judges which of next MMC transmission times from the first host 101 and the second host 102 is earlier. If the next MMC transmission time from the first host 101 is earlier, the process goes to a step S704, while if the next MMC transmission time from the second host 102 is earlier, the process goes to a step S702.

In the step S702, the first device 111 tries to start a session with the second host 102 via the radio channel B. After the first device 111 transmits the transition notification 627 to the sleep mode to the second host 102, the first device 102 receives an MMC 721 from the second host 102 before receiving an MMC 723 from the first host 101.

Next, in a step S703, the first device 111 acquires transmission time information of a next MMC included in the MMC 721. The first device 111 transmits a connection continuation notification 722 to the second host 102 within a DNTS period 304 allotted in the MMC 721 from the second host 102.

Thereby, forcible cut-off due to absence of access for a predetermined time after the second host 102 receives the sleep mode transition notification 627 from the first device 111 may be evaded. Thereafter, the process returns to the step S701 and similar processings are repeated.

In the step S704, the first device 111 tries to start a session with the first host 101 via the radio channel A. After the first device 111 transmits the transition notification 627 to the sleep mode to the second host 102, the first device 111 receives an MMC 723 from the first host 101.

Next, in a step S705, the first device 111 acquires transmission time information of a next MMC included in the MMC 723, starts up a fourth timer, and continues to allow allotment of the radio channel time from the first host 101 until the fourth timer finishes counting.

Next, the first device 111 transmits a transition notification 724 to an awake mode to the first host 101 within a DNTS period 304 allotted in the MMC 723 from the first host 101, whereby the first device 111 allows allotment of the radio channel time 302 from the first host 101 to the first device 111. In other words, the first device 111 radio-transmits the transition notification 724 to the awake mode to the first host 101 in a transition state to the sleep mode with respect to the first host 101, in order to enable allotment of the radio channel time 302.

The first device 111 transmits the sleep mode transition notification 424 to the first host 101 in FIG. 4, whereby the first device performs transition to the sleep mode. Then, the first host 101 does not allot the radio channel time 302 to the first device 111. The first device performs transition to the awake mode by transmitting the awake mode transition notification 724 to the first host 101. Thereby, the first host 101 allows allotment of the radio channel time 302 to the first device 111, enabling data transmission/reception.

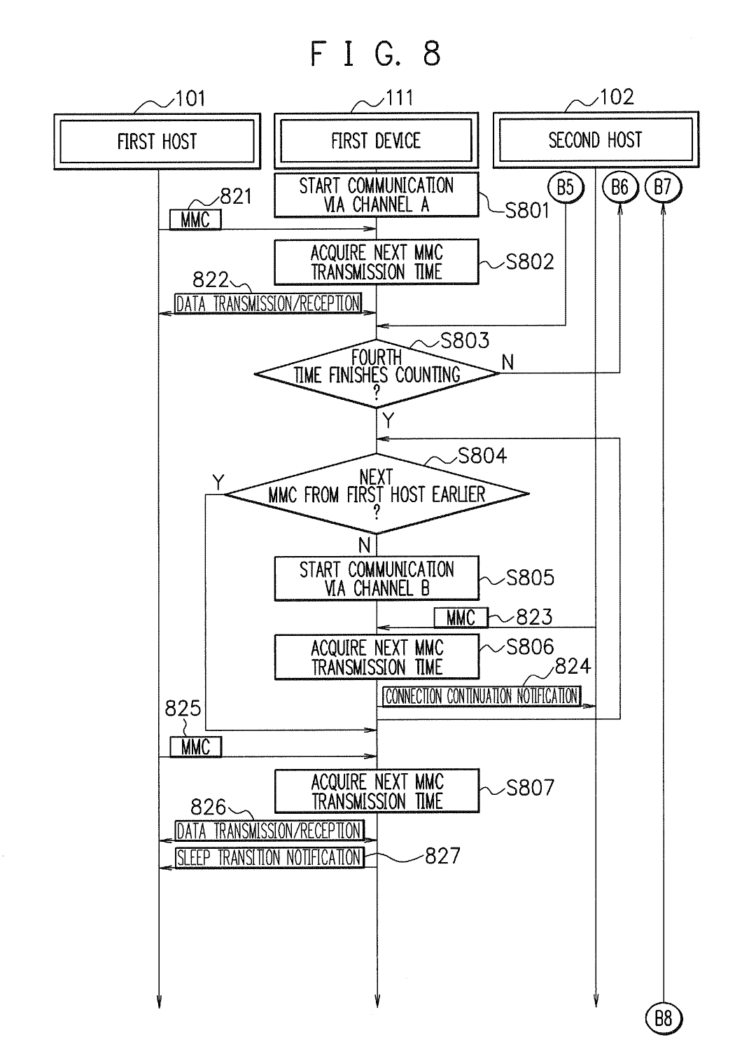

Next, in a step S706, the first device judges which of next MMC transmission times from the first host 101 and the second host 102 is earlier. If the next MMC transmission time from the first host 101 is earlier, the process goes to a step S707, while if the next MMC transmission time from the second host 102 is earlier, the process goes to a step S801 in FIG. 8.

In the step S707, the first device 111 tries to start a session with the second host 102 via the radio channel B. The first device 111 receives an MMC 725 from the second host 102 before the fourth timer finishes counting.

Next, in a step S708, the first device 111 acquires transmission time information of a next MMC included in the MMC 725. Next, the first device 111 transmits a connection continuation notification 726 to the second host 102 within a DNTS period 304 allotted in the MMC 725 received from the second host 102, to evade forcible cut-off. Thereafter, the process goes to a step S803 in FIG. 8.

In a step S801 in FIG. 8, the first device 111 tries to start a session with the first host 101 via the radio channel A. Next, the first device 111 receives an MMC 821 from the first host 101 before the fourth timer finishes counting.

Next, in a step S802, the first device 111 acquires transmission time information of a next MMC included in the MMC 821. If a radio channel time 302 for transmission or reception of data between the first host 101 and the first device 111 is allotted, the first device 111 performs transmission or reception processing 822 of data to/from the first host 101 within the radio channel time 302 indicated by the MMC 821. In other words, the first device 111 performs the radio communication processing 822 of data to the first host 101 in a transition state to the sleep mode with respect to the second host 102 and in a transition state to the awake mode with respect to the first host 101.

Next, in the step S803, it is checked whether or not the fourth timer has finished counting a timer value. If counting is not finished, the process returns to the step S706 in FIG. 7 and similar processings are repeated, while if counting is finished, the process goes to a step S804.

In the step S804, the first device 111 judges which of next MMC transmission times from the first host 101 and the second host 102 is earlier. If the next MMC transmission time from the second host 102 is earlier, the process goes to a step S805. If the next MMC transmission time from the first host 101 is earlier, the first device 111 receives an MMC 825 from the first host 101 and the process goes to a step S807.

In the step S805, the first device 111 tries to start a session with the second host 102 via the radio channel B. After the fourth timer finishes counting, the first device 111 receives an MMC 823 from the second host 102 before receiving the MMC 825 from the first host 101.

Next, in a step S806, the first device 111 acquires transmission time information of a next MMC included in the MMC 823. Next, the first device 111 transmits a connection continuation notification 824 within a DNTS period 304 allotted in the MMC 823 received from the second host 102, to evade forcible cut-off. Thereafter, the process returns to the step S804 and similar processings are repeated.

In the step S807, the first device 111 acquires transmission time information of a next MMC included in the MMC 825. If a radio channel time 302 for transmission or reception of data between the first host 101 and the first device 111 is allotted in the MMC 825 received from the first host 101, the first device 111 performs a transmission or reception processing 826 of data to/from the first host 101 during the radio channel time 302. After the fourth timer finishes counting, if the first device 111 receives the MMC 825 from the first host 101, the first device 111 transmits a transition notification 827 to a sleep mode to the first host 101 within a DNTS period 304 allotted in the MMC 825 received from the first host 101, performs transition to the sleep mode, and declares cessation of transmission/reception of data.

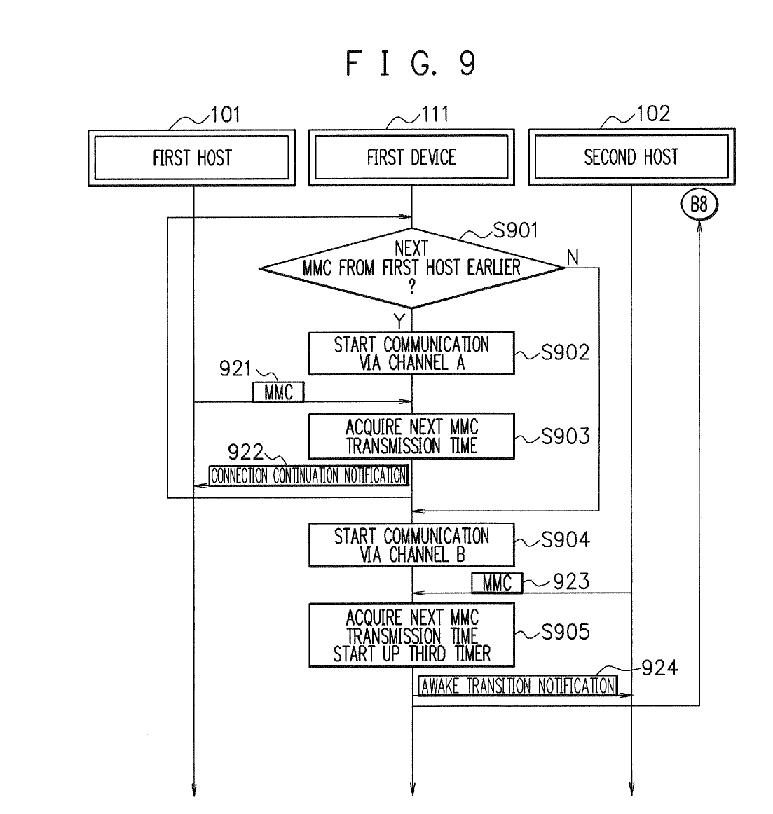

Next, in a step S901 in FIG. 9, the first device 111 judges which of next MMC transmission times from the first host 101 and the second host 102 is earlier. If the next MMC transmission time from the first host 101 is earlier, the process goes to a step S902, while if the next MMC transmission time from the second host 102 is earlier, the process goes to a step S904.

In the step S902, the first device 111 tries to start a session with the first host 101 via the radio channel A. Next, after transmitting the transition notification 827 to the sleep mode to the first host 101, the first device 111 receives an MMC 921 from the first host 101.

Next, in a step S903, the first device 111 acquires transmission time information of a next MMC included in the MMC 921. Next, the first device 111 transmits a connection continuation notification 922 to the first host 101 within a DNTS period 304 allotted in the MMC 921 from the first host 101, to evade forcible cut-off. Thereafter, the process returns to the step S901 and similar processings are repeated.

In the step S904, the first device 111 tries to start a session with the second host 101 via the radio channel B. Next, after transmitting the transition notification 827 to the sleep mode to the first host 101, the first device 111 receives an MMC 923 from the second host 102.

Next, in a step S905, the first device 111 acquires transmission time information of a next MMC included in the MMC 923 and starts up the third timer. The first device 111 transmits a transition notification 924 to an awake mode within a DNTS period 304 allotted in the MMC 923 from the second host 102, whereby the first device 111 performs transition to the awake mode. Thereby, the second host 102 allows allotment of the radio channel time to the first device 111. The first device 111 continues to allow the allotment of the radio channel time from the second host 102 until the third timer finishes counting. Thereafter, the process returns to the step S506 in FIG. 5. Thereafter, the first device 111 performs similar processings as in a case that the allotment of the radio channel time is allowed to the second host 102 before.

As stated above, according to the present embodiment, in the device 111 starting sessions with the plural hosts 101, 102, in order to allow allotment of the radio channel time to only either one host of hosts after the sessions are started, the transition to the sleep mode is notified to all the hosts except the above-described one host. Further, the host to be allowed the allotment of the radio channel time to the above-described device 111 is periodically switched among the hosts having started the sessions.

In the present embodiment, in the device 111 starting the sessions with the plural hosts 101, 102, the transition to the sleep mode is notified to all the hosts except one host among the hosts having started the sessions, whereby the radio channel is allotted only by the above-described one host. Further, by periodically switching the host to be allowed the allotment of the radio channel time, sessions with a plurality of channels may be possible while maintaining the above-described control and compatibility with the wireless USB compliant products.

The present embodiment may be realized by the computer in FIG. 2 executing a computer program. In addition, a means for providing a computer program to a computer, for example, a computer-readable recording medium such as a CD-ROM recording that computer program or a transmission medium such as the Internet transmitting that computer program may be also applied as an embodiment. Further, a computer program product such as a computer-readable recording medium recording the above-described computer program may be applied as an embodiment. The above-described computer program, recording medium, transmitting medium and computer program product are included in a range of the present embodiments. As the recording medium, for example, a flexible disk, a hard disk, an optical disk, a magnetic optical disk, a CD-ROM, a magnetic tape, a non-volatile memory card, and a ROM may be used.

The present embodiments are to be considered in all respects as illustrative and no restrictive, and all changes which come within the meaning and range of equivalency of the claims are therefore intended to be embraced therein. The embodiments may be embodied in other specific forms without departing from the spirit or essential characteristics thereof.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

It may be possible to radio-communicate with a plurality of hosts while compatibility with another radio communication device (for example, a wireless USB compliant product) are maintained.

What is claimed is:

1. A communication method comprising:
transmitting a first transition notification of a sleep mode to make allotment of a channel time unnecessary to a first host; and
communicating first data to a second host in a first transition state which the first host transits to the sleep mode.

2. The communication method according to claim 1, the method further comprising:
transmitting a second transition notification of an awake mode to enable the allotment of the channel time to the first host which is in the first transition state; and
communicating second data to the first host in a second transition state which the first host transits to the awake mode.

3. The communication method according to claim 1, the method further comprising:
transmitting a third transition notification of a sleep mode to make allotment of a channel time unnecessary to a second host;
transmitting a fourth transition notification of an awake mode to enable the allotment of the channel time to the first host which is in the first transition state; and
communicating data to the first host in a third transition state which the second host transits to the sleep mode and in the second transition state.

4. The communication method according to claim 1, the method further comprising:
transmitting a first connection notification to request connection start to the first host; and
transmitting a second connection notification to request connection start to the second host.

5. The communication method according to claim 1, the method further comprising
transmitting a first connection continuation notification to the first host to evade forcible cut-off, in the first transition state.

6. The communication method according to claim 1,
wherein the transmitting the first transition notification and the communicating the first data are performed by communicating by a wireless USB (Universal Serial Bus).

7. The communication method according to claim 6,
wherein the transmitting the first transition notification is performed by transmitting the transition notification to the sleep mode within a DNTS (Device Notification Time Slot) period.

8. The communication method according to claim 6,
wherein the communicating the first data is performed by receiving an MMC (Micro-scheduled Management Command) control signal from the second host and communicating data to the second host within a channel time indicated by the MMC control signal.

9. A communication device comprising:
a sleep mode transition notification transmitter transmitting a transition notification to a sleep mode to make allotment of a channel time unnecessary to a first host; and
a data communicator communicating data to a second host in a transition state to the sleep mode with respect to the first host.

10. The communication device according to claim 9, further comprising
an awake mode transition notification transmitter transmitting a transition notification to an awake mode to enable the allotment of the channel time to the first host in the transition state to the sleep mode with respect to the first host,
wherein the data transmitter communicates data to the first host in a transition state to the awake mode with respect to the first host.

11. The communication device according to claim 9, further comprising
an awake mode transition notification transmitter transmitting a transition notification to an awake mode to enable the allotment of the channel time to the first host in the transition state to the sleep mode with respect to the first host,
wherein the sleep mode transition notification transmitter transmits a transition notification to a sleep mode to make allotment of a channel time unnecessary to the second host, and
wherein the data communicator communicates data to the first host in a transition state to the sleep mode with respect to the second host and in a transition state to the awake mode with respect to the first host.

12. The communication device according to claim 9, further comprising
a connection notification transmitter transmitting a connection notification to request connection start to the first host and transmitting a connection notification to request connection start to the second host.

13. The communication device according to claim 9, further comprising
a connection continuation notification transmitter transmitting a connection continuation notification to the first host to evade forcible cut-off, in the transition state to the sleep mode with respect to the first host.

14. The communication device according to claim 9,
wherein the sleep mode transition notification transmitter and the data communicator communicate by a wireless USB (Universal Serial Bus).

15. The communication device according to claim 14,
wherein the sleep mode transition notification transmitter transmits the transition notification to the sleep mode within a DNTS (Device Notification Time Slot) period.

16. The communication device according to claim 14,
wherein the data communicator receives an MMC (Micro-scheduled Management Command) control signal from the second host and communicates data to the second host within a channel time indicated by the MMC control signal.
